(19) United States
(12) Patent Application Publication
(10) Pub. No.: US 2025/0270863 A1
(43) Pub. Date: Aug. 28, 2025

(54) Playless Hinge System with Releasable Hinge Pin

(71) Applicant: Murphy Door Inc., West Haven, UT (US)

(72) Inventors: Jeremy Barker, West Haven, UT (US); Robert Charles Cooley, West Haven, UT (US)

(21) Appl. No.: 19/063,494

(22) Filed: Feb. 26, 2025

Related U.S. Application Data
(60) Provisional application No. 63/558,036, filed on Feb. 26, 2024.

(51) Int. Cl. E05D 7/04; E05D 3/02; E05D 7/10

(52) U.S. Cl. CPC E05D 7/04; E05D 3/02; E05D 7/1005; E05D 2007/0469; E05D 2007/0484; E05D 2007/1027; E05Y 2600/41; E05Y 2900/132

(57) ABSTRACT

The invention presents an innovative design for door hinge systems to eliminate excessive spacing between the door and jamb, offering use of the hinge system in more limited spaces. The invention also allows use of a hinge system for use in hidden or secret panel doors. The invention comprises a bottom hinge assembly comprising an axial load arm capable of distributing weight, and a top hinge assembly comprising a releasable hinge pin to provide a high degree of customization for users.

### CROSS-REFERENCE TO RELATED APPLICATIONS

This application claims priority to U.S. Provisional Application No. 63/558,036 filed on Feb. 26, 2024, which is incorporated herein by reference in its entirety to the full extent permitted by law.

### FIELD OF THE INVENTION

The present invention relates generally to playless hinge systems with releasable hinge pins that are suitable for a variety of applications. More specifically, the invention relates to playless hinge hardware with releasable hinge pins with enhanced precision with respect to door positioning.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention or its embodiments.

Traditional hinges in the art are known to support a door for opening and closing in a pivoting motion. Broadly speaking, the hinge is a type of bearing that connects two solid objects, allowing only a limited angle of rotation between them. Two objects connected by a typical hinge rotate relative to each other about a fixed axis of rotation.

In many instances, there are various types of hinges used to connect a door separating two spaces, such as two rooms, or the open part of a piece of furniture. A respective door jamb is created to keep the door in place and providing it with an attachment point, such as in each of the two upright (horizontal and vertical) parts of a doorframe, on one of which the door is hung. The jamb is placed in such a way that the door or open furniture part can rotate about an axis of rotation to provide access to the space on the other side of the door.

Often, hinges comprise two fastening members. One of the members can be recessed in the door or open furniture part, for example, in their outer edge. Another member can be recessed on the respective door jamb. The hinge fastening members are joined to each other by a connecting device, such as arms which are articulated to varying degrees, which allows them to move relative to each other between two limit positions corresponding to the open and closed positions of the door or open furniture part.

The recessed location on the outer, bottom, or top edge of the door will require a minimum thickness, often greater than a single sheet of material, requiring the door be constructed from multiple layers of material or having an internal structure to create the minimum thickness required for the hinge. This required thickness creates a space requirement for the spaces where a hinge may properly operate and additional need for necessary hinge adjustments to appropriately conform to such limited spaces.

Moreover, axial loads must also be considered for a hinge to properly function. An axial load is a force administered along the lines of an axis. It is also commonly used to describe a specific strength of materials known as their uniaxial compressive or tensile strength and to find the variation of their strength with increasing confining pressure. A mirror or decorative panel designed to conceal a doorway can be heavy and place a heavy axial force on the hinges. Often, the axial load can cause a hinge to sag and deform after a duration. If the load is heavy enough, such as a large mirror, the hinges may deteriorate, forming undesirable spaces between their pivoting members. The extra space can cause vibrations and abrasive wear on the hinge components, eventually rendering the hinge inoperable.

In view of the foregoing, traditional hinges have weak structural integrity making them particularly unsuitable for applications where space is limited or where axial loads are great, due to their required undesirable recessing or excess door thickness. As such, more optimal approaches to placement, spacing, dampening of periodic motions, and reduction of abrasive wear in traditional hinge is needed.

### SUMMARY OF THE INVENTION

The present invention provides a novel hinge system designed to enhance the functionality and adjustability of door assemblies over traditional systems. This hinge system comprises two main components: a top hinge assembly and a bottom hinge assembly. The system enables precise door positioning through horizontal and vertical adjustments.

The bottom hinge assembly includes a door member and a jamb member, both of which can be adjusted horizontally and vertically for precise door positioning. An axial load arm housing allows for versatile door swing orientations, and an adjustable axial load arm fine-tunes the gaps at the top and bottom of the door. The axial load arm can be retracted into the axial load arm housing, thereby reducing the clearance needed at the top and bottom of the door for installation; and once the door is in place, the axial load arm can be extended again to engage the thrust bearing and securely hold the sections of the bottom hinge assembly together. A thrust bearing option provides additional support and minimizes movement during operation. The bottom door hinge plate and axial load arm housing are affixed such that the assembly may be reconfigured to accommodate right hand or left had placement on the door.

The top hinge assembly mirrors the bottom assembly's adjustability with both horizontally and vertically adjustable placement, allowing lateral positioning of the door relative to the jamb. It comprises a door member with a rotatable releasable hinge pin, accommodating both right-hand and left-hand swing doors. A releasable hinge pin bearing option ensures stability and dampens movement. The top door hinge plate and releasable hinge pin housing are affixed such that the assembly may be reconfigured to accommodate right hand or left had placement on the door.

An objective of the present invention is to eliminate at least partially excessive spacing between the door and jamb. This allows for more appropriate height, lateral spacing, and tilt of the door relative to the jamb, allowing the hinge system to properly function in more limited spaces. The tighter, load distributing bearing provides a pivoting motion that also minimizes sagging by the door and potential maintenance problems.

Another objective is to provide a functional hinge system for hidden or secret panel doors that is easy to operate and that can conceal the hinge system hardware and obscure the hinge system hardware from view. Current hinge systems that are recessed into the top and bottom, or sides of the door, are limited to certain spaces and require specialized knowledge and tooling for installation. The present invention allows for attachment to a vertical surface using common fasteners and does not require the extensive work of recessing the device while still allowing for concealment of the hinge system hardware.

The invention enhances door operation in areas not otherwise possible, simplifies attachment of the hinge system to the door, offers extensive adjustability, and minimizes unwanted movement, providing a versatile solution for various door types and configurations.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and may be learned by the practice of the invention as set forth hereinafter.

### BRIEF DESCRIPTION OF THE DRAWINGS

FIG. 1 illustrates an embodiment of the hinge system (100) comprising a top hinge assembly (300) and a bottom hinge assembly (200).

FIGS. 2A, 2B, 2C, and 2D are views illustrating an exemplary bottom hinge assembly (200) where FIG. 2A is a perspective view, FIG. 2B is a top view, FIG. 2C is a front view, and FIG. 2D is a side view, of the exemplary bottom hinge assembly (200).

FIGS. 2E, 2F, 2G, 2H, 2J, and 2K are views illustrating an exemplary bottom hinge door member (202) where FIG. 2E is a perspective view, FIG. 2F is a top view, FIG. 2G is a back view, FIG. 2H is a side view, FIG. 2J is a front view, and FIG. 2K is a section view, of the exemplary bottom hinge door member (202).

FIGS. 2L, and 2M illustrate an exemplary bottom hinge door member (202) with the axial load arm (224) in a retracted position with the axial load arm shoulder (242) fully recessed inside of the axial load arm trunnion (226) partially recessed inside of the axial load arm housing (222) where FIG. 2L is a front view, and FIG. 2M is a section view, of the exemplary bottom hinge door member (202).

FIGS. 2N, and 2P are views illustrating an exemplary axial load arm (224) where FIG. 2N is a perspective view and FIG. 2P is a front view, of the exemplary axial load arm (224).

FIGS. 2Q, 2R, and 2S are views illustrating an exemplary bottom hinge jamb member (204) where FIG. 2Q is a top perspective view, FIG. 2R is a top view, and FIG. 2S is a bottom perspective view, of the exemplary bottom hinge jamb member (204).

FIGS. 3A, 3B, 3C, and 3D are views illustrating an exemplary top hinge assembly (300) where FIG. 3A is a side view, FIG. 3B is a front view, FIG. 3C is a perspective view, and FIG. 3D is a bottom view, of the exemplary top hinge assembly (300).

FIGS. 3E, 3F, 3G, 3H, 3J, and 3K are views illustrating an exemplary top hinge door member (302) where FIG. 3E is a perspective view, FIG. 3F is a top view, FIG. 3G is a back view, FIG. 3H is a side view, FIG. 3J is a front view, and 3K is a section view, of the exemplary top hinge door member (302).

FIGS. 3L and 3M are views illustrating an exemplary top hinge jamb member (304) where FIG. 3L is a bottom view and FIG. 3M is a top perspective view, of the exemplary top hinge jamb member (304).

FIGS. 4A, 4B, 4C, and 4D are views illustrating an exemplary releasable hinge pin (400) where FIG. 4A is a top view, FIG. 4B is a perspective view, FIG. 4C is a front view, and FIG. 4D is a side view, of the exemplary releasable hinge pin (400).

FIGS. 5A, 5B, and 5C are views illustrating a sectioned environmental perspective view of an elongated releasable hinge pin and extraction tool where FIG. 5A is a top perspective view, FIG. 5B is a side view, and 5C is a section view.

It should be noted that the figures herein are not to scale, and the hinge system illustrated is not limited to the scale shown in the figures.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. While the present invention is capable of being embodied in various forms, for simplicity and illustrative purposes, the principles of the invention are described by referring to several embodiments thereof. It is understood, however, that the present disclosure is to be considered as an exemplification of the claimed subject matter, and is not intended to limit the appended claims to the specific embodiments illustrated. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

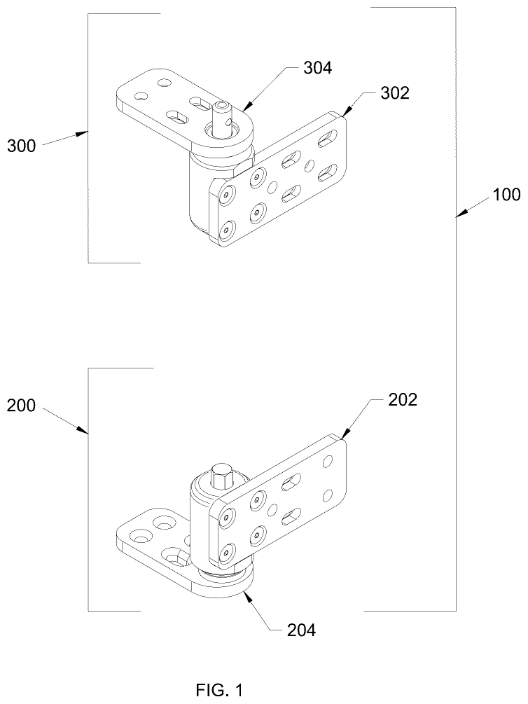

FIG. 1A through 3M illustrate an exemplary embodiment of the hinge system (100) comprising a top hinge assembly (300) and a bottom hinge assembly (200). The top hinge assembly (300) comprises of a top hinge door member (302) and top hinge jamb member (304). The bottom hinge assembly (200) comprises of a bottom hinge door member (202) and a bottom hinge jamb member (204). In one embodiment of the present inventions, a hinge system (100) may be attached to a panel door which may consist of a single sheet of wood without the need for creating pockets or recesses to mount the hinge system. The top and bottom hinge assemblies (300, 200) cooperate along a common longitudinal axis of a door and position at different elevations on a jamb. The hinge system (100) may be constructed from materials such as steel, aluminum, brass, reinforced polymer, a combination thereof, or other suitable material sufficient to provide structural durability.

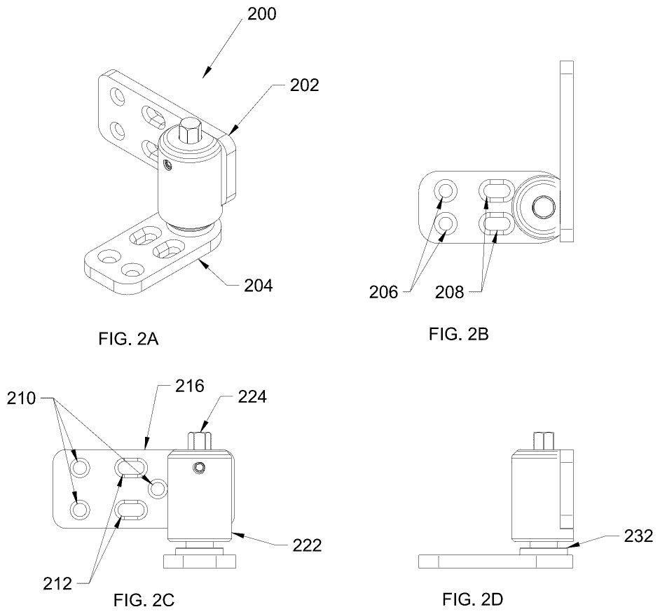

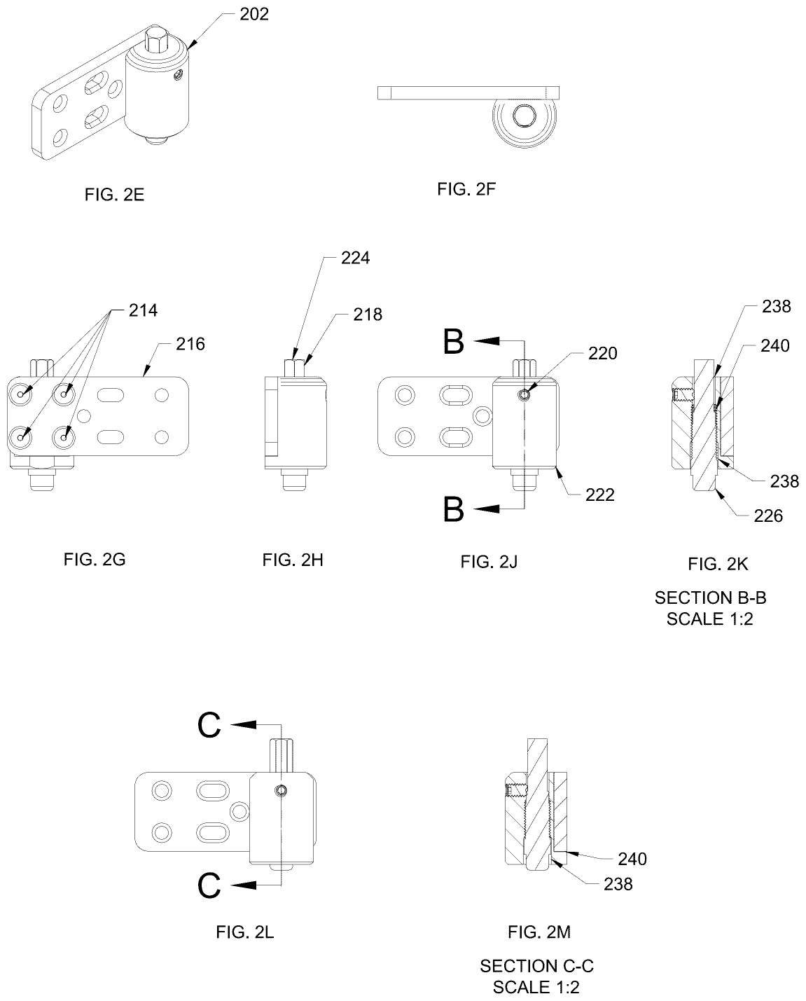

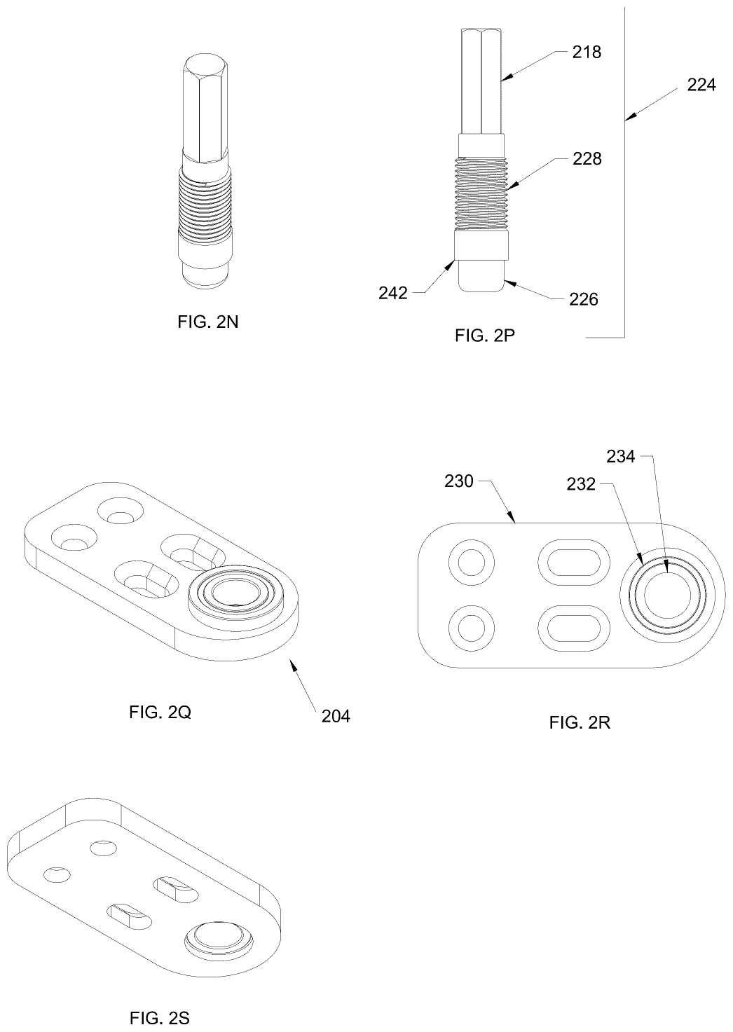

FIGS. 2A, 2B, 2C, and 2D provide an exemplary embodiment of the bottom hinge assembly (200) when assembled and mounted on a door and jamb.

The bottom hinge door member (202) is secured to the back vertical surface of a thin-profile door (not shown) made of materials such as a single slab of MDF, plywood, metal, or other suitable material by attaching screws or bolts. This attachment is achieved by fastening bottom hinge door member (202) through the circular door mounting apertures (210) and non-circular door mounting apertures (212). The bottom hinge jamb member (204) is fastened to the horizontal surface of a threshold or the floor beneath the door (not shown) through circular jamb mounting apertures (206) and non-circular jamb mounting apertures (208).

The non-circular jamb mounting apertures (208) allow for fine-tuning the front-to-back placement of the bottom hinge jamb member (204) relative to the jamb and allowing the door to be positioned so that the front surface of the door is flush to the wall and front surface of the jamb. Some embodiments of the present invention provides a functional hinge system (100) that allows the door to be positioned so that the front surface of the door is flush to the wall and front surface of the jamb, which can allow decorative panels to be installed over the wall and door to better conceal a hidden or secret door that obscures the hinge system (100) hardware from view.

The non-circular door mounting apertures (212) provide adjustment in the horizontal side-to-side placement of the bottom hinge door member (202) on the door. This allows the side clearances between the door and jamb to be reduced. Some embodiments of the present invention provide a functional hinge system (100) that allows the side clearances between the door and jamb to be reduced, which can allow for better concealment of a hidden or secret door that obscures the hinge system (100) hardware from view.

The bottom hinge assembly (200) utilizes an axial load arm (224) threadedly attached axially through an axial load arm housing (222) which is removably attached to the bottom hinge door plate (216). The axial load arm (224) interfaces with the thrust bearing mounted in the bottom hinge jamb member to dampen periodic motion and prevent sagging.

FIGS. 2E, 2F, 2G, 2H, 2J, and 2K are views illustrating an exemplary bottom hinge door member (202) of an embodiment of the bottom hinge assembly (200).

The exemplary bottom hinge door member (202) comprises a bottom hinge door plate (216), an axial load arm housing (222) that can be removably attached to the bottom hinge door plate (216) using a plurality of fasteners (214) and supported by the axial load arm housing shoulder (240).

In an exemplary embodiment, the axial load arm housing (222) is arranged in a way that the axis of the axial load arm (224) is perpendicular to the bottom hinge door plate (216), and perpendicular to the mounting surface of the bottom hinge door plate to the door. The advantage of this arrangement is a reduction in the overall required thickness of the door structure, allowing proper operation and also eliminating the need for specialized tools for mounting or recessing the hinge assembly in the top surface of the door.

The bottom hinge door plate (216) is affixed radially to the axial load arm housing (222). The axial load arm housing shoulder (240) supports the load attached radially to the axial load arm housing (222) through the bottom hinge door plate (216) and translates it to an axial load at the axial load arm (224). This axial load is distributed through the axial load arm shoulder (242) to the thrust bearing (232) and bottom hinge jamb plate (230).

The axial load arm housing shoulder (240) distributes the weight of the door from the fasteners (214) and prevents a sheer load from being applied to them. This attachment design allows for repositioning the axial load arm housing (222) to accommodate both right-hand and left-hand swing doors because the axial load arm housing (222) can rotate freely in either direction without a physical limit based on the design. The axial load arm (224) is threaded axially through the axial load arm housing (222), and the protrusion of the axial load arm trunnion (226) can be adjusted by using a wrench or other tool on the tool contact points (218) to adjust the axial load arm (224), thereby allowing for precise adjustments in the gaps at the top and bottom of the door.

The capacity to adjust height of the door after installation reduces the need for excessive spacing at the top and bottom of the door. This reduces the clearance space needed between the top and bottom of the door and the jamb. Some embodiments of the present invention provide a functional hinge system (100) capable of adjusting height of the door after installation to minimize excessive spacing at the top and bottom of the door to better conceal the existence of a hidden or secret door that obscures the hinge system (100) hardware from view.

An axial load arm locking screw (220) can be tightened against the tool contact points (218) to adjust the axial load arm (224), locking the axial load arm into place and preventing the axial load arm (224) from moving vertically within the axial load arm housing (222).

FIGS. 2L and 2M depict an embodiment of the bottom hinge door member with the axial load arm (224) and axial load arm trunnion (226) fully retracted into the annular recess (238) at the bottom or lower extreme of the axial load arm housing (222), and the axial load arm locking screw (220) shown in a loosened position, allowing free adjustment of the axial load arm (224). With the load arm in the fully retracted position, the required clearance between the top and bottom of the door, and the jamb are reduced, allowing the door to be maneuvered into place with minimal additional space requirements.

FIGS. 2N and 2P provide an embodiment of the axial load arm (224), which consists of an axial load arm trunnion (226), an axial load arm threaded section (228), an axial load arm shoulder (242) and tool contact points (218) for adjusting the position of the axial load arm within the axial load arm housing (222).

FIGS. 2Q, 2R, and 2S provide an embodiment of the bottom hinge jamb member (204). A bottom hinge jamb plate (230), a thrust bearing (232), and is equipped with a bottom hinge jamb member aperture (234) capable of accepting the axial load arm trunnion (226). This member is affixed to the threshold of a door jamb or directly to the floor (not shown), providing support for the door's weight axially through the axial load arm (224). Additionally, a thrust bearing (232) may be incorporated into the bottom jamb hinge member to offer support for the axial load and minimize movement between the members.

The axial load arm (224) may be threadedly attached axially through the axial load arm housing (222). The axial load arm shoulder (242) distributes the weight of the door to the thrust bearing (232), providing enhanced structural support and prevents periodic movements. The axial load arm trunnion (226) having a substantially smooth surface may be extended to engage the bottom hinge jamb member aperture (234) in the thrust bearing (232). This design effectively dampens any periodic movement, excess spacing, play, vibrations, or abrasive deterioration of the bottom hinge assembly (200) during operation while supporting the door. Those skilled in the art will recognize that the thrust bearing (232) as disclosed is efficacious for supporting heavier axial loads and slow rotational movement.

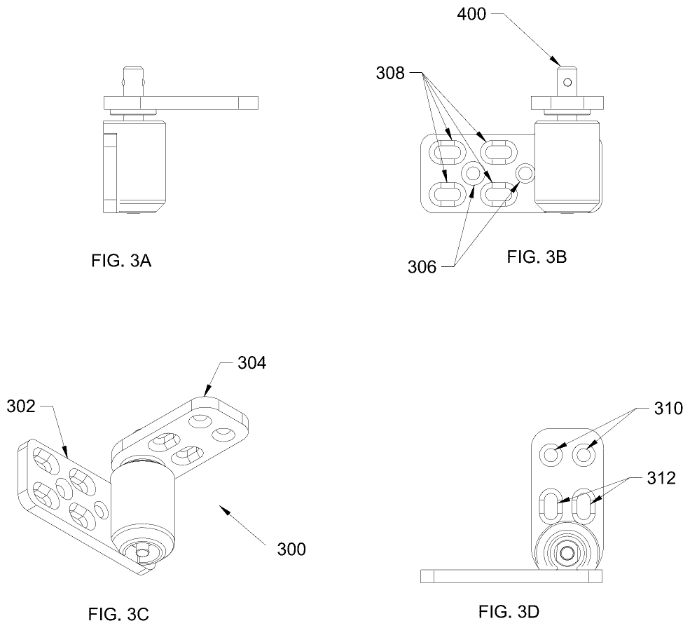

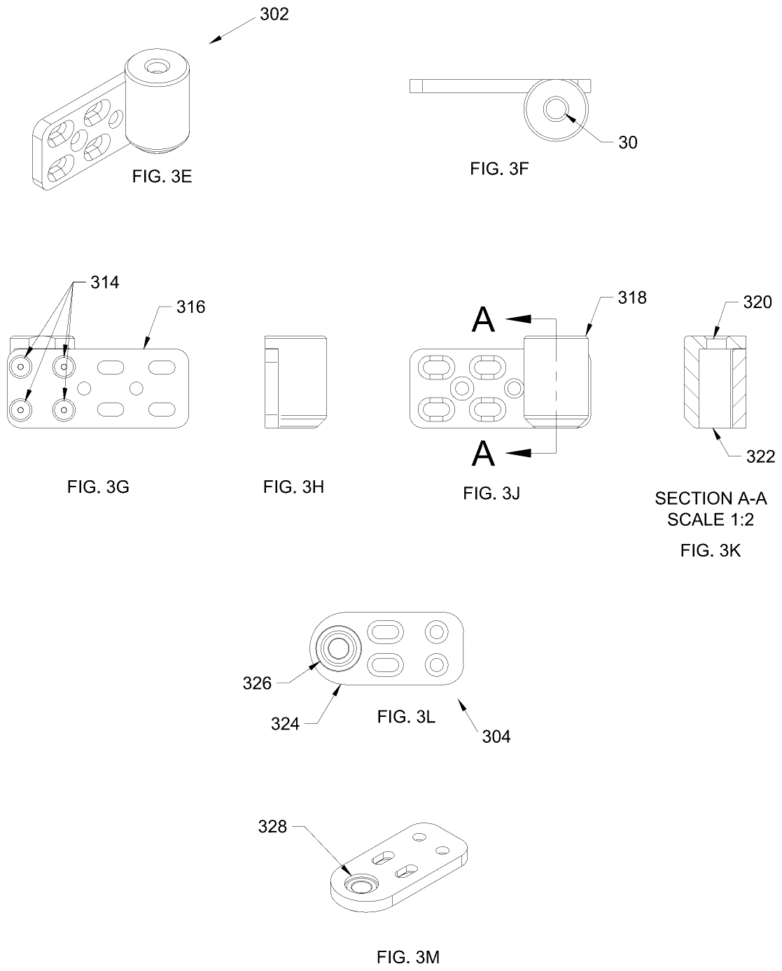

FIGS. 3A, 3B, 3C, and 3D illustrate an embodiment of the top hinge assembly (300) when fully assembled and mounted on a door and jamb.

The top hinge door member (302) of the top hinge assembly (300) is secured to the back vertical surface of a thin-profile door (not shown) using fasteners through the non-circular door mounting apertures (308). The lateral positioning of the door relative to the jamb can be adjusted using the non-circular apertures (308). Some embodiments of the present invention provide a functional hinge system (100) capable of adjusting the lateral positioning of the door relative to the jamb such that side clearances between the door and jamb are reduced to allow for better concealment of the existence of a hidden or secret door by obscuring the hinge system (100) hardware from view. The circular door mounting apertures (306) are used to secure the hinge placement on the door once the desired horizontal placement has been found.

Similar to the bottom hinge assembly (200), the top hinge jamb member (304) is attached to the horizontal surface of a threshold or above the door using fasteners through circular jamb mounting apertures (310) and non-circular jamb mounting apertures (312). The non-circular jamb mounting apertures (312) allow for fine-tuning the front-to-back placement of the top hinge jamb member (304) on the jamb. Some embodiments of the present invention provide a functional hinge system (100) that can position a door such that the front surface of the door is flush to the wall and front surface of the jamb, and allowing decorative panels to be installed over the wall and door, which can allow for better concealment of a hidden or secret door that obscures the hinge system (100) hardware from view.

FIGS. 3E, 3F, 3G, 3H, 3J, and 3K depict an embodiment of the top hinge door member (302). This component includes a top hinge door plate (316) and a releasable hinge pin housing (318) that can be removably attached to the top hinge door plate (316) using a plurality of fasteners (314).

Similar to the axial load arm housing in the bottom hinge assembly, the releasable hinge pin housing (318) can be repositioned to accommodate both right-hand and left-hand swing doors. The releasable hinge pin housing (318) features a top door hinge aperture (320) running axially through it, a top door hinge recess (322), allowing the passage of a releasable hinge pin (400) that can be rotatably secured to the top hinge jamb member (304).

The releasable hinge pin housing (318) is arranged in a way that the axis of the releasable hinge pin (400) is perpendicular to the top hinge door plate (316) and perpendicular to the mounting surface of the top hinge door plate (316) to the door. The advantage of this is a reduction in the required thickness of the door structure allowing for proper operation and eliminating the need for specialized tools for mounting or recessing the hinge assembly in the top surface of the door.

The top door hinge recess (322) encloses the releasable hinge pin (400) on all sides except for the bottom, protects the releasable hinge pin from damage, and allows access using a hinge pin tool.

FIGS. 3L and 3M display an embodiment of the top hinge jamb member (304). A top hinge jamb plate (324), equipped with a top hinge jamb member aperture (328), is affixed to the top horizontally mounted member of a door jamb that shares a common rotational axis with the bottom hinge assembly.

To support the top radial load and inhibit movement between the members, the top hinge jamb member (304) may be fitted with a releasable hinge pin bearing (326). This design effectively dampens any periodic movement, excess spacing, play, vibrations, or abrasive deterioration of the top hinge assembly (300) during operation while supporting the door.

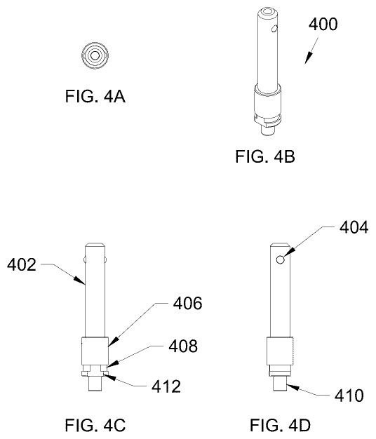

FIGS. 4A, 4B, 4C, and 4D illustrate various perspective views of an elongated releasable hinge pin (400) with retractable latch pins. The releasable hinge pin (400) comprises a hollow cylindrical shaft (402), two retractable latch pins (404), a proximal sleeve (406) defining an axial recess (408), and a depressible button (410) extending upwardly from a proximal bottom end of the hinge pin (400). Tool access points (412) create access to the axial recess for the hinge pin extraction tool (500).

The shaft (402) defines a hollow passageway. The pin (400) is adapted to retract latch pins (404) when a depressible button (410) is depressed. In this manner, a hinge assembly can be easily disassembled and reassembled quickly. The extended latch pins (404) prevent extraction of the pin (400) from a hinge assembly while retracted latch pins (404) permit extraction.

The proximal sleeve (406) is disposed on the proximal end of the pin (400).

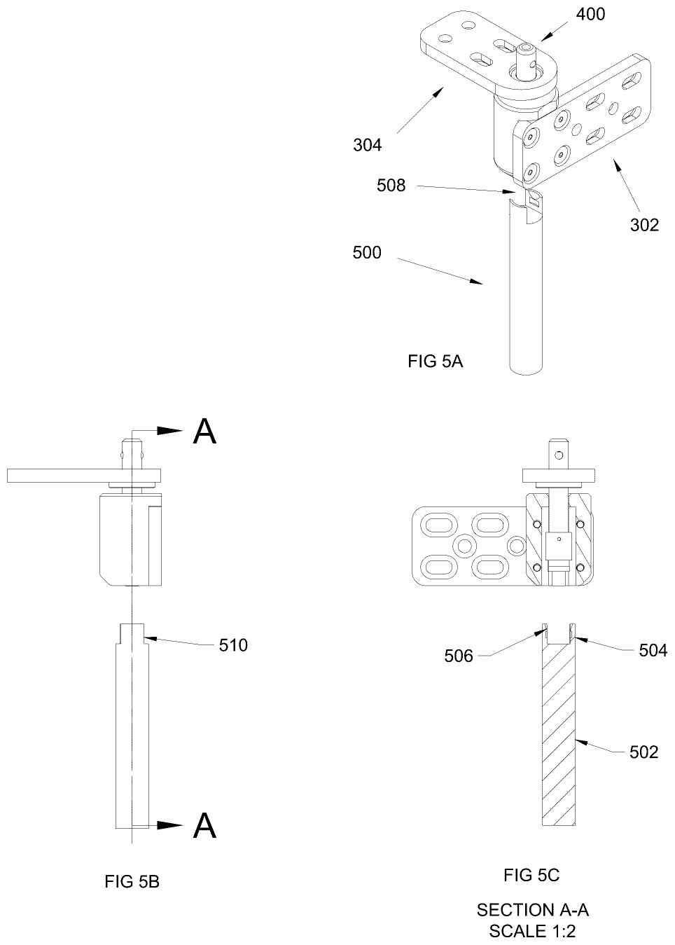

FIGS. 5A-5C illustrate a sectioned environmental perspective view of an elongated releasable hinge pin and extraction tool (500).

The tool (500) comprises a cylindrical body (502) having an open bottom end (508). The open bottom end (508) is defined by a cylindrical sidewall (504) and two open sides (510) having a cantilevered interior rim (506) for gripping a proximal sleeve (406), while depressing the button (410). The cylindrical sidewall (504), open sides (510), and cantilevered interior rim (506) align with the extraction tool access points to fit the tool (500) over the end of the proximal sleeve (406) and rotate the cantilevered interior rim (506) into the axial recess, depressing the button (410).

While the invention has been described in terms of several preferred embodiments, it should be understood that there are many alterations, permutations, and equivalents that fall within the scope of this invention. It should also be noted that there are alternative ways of implementing the apparatus of the present invention. It is therefore intended that the appended claim includes all such alterations, permutations, and equivalents as fall within the true spirit and scope of the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

We claim:

1. A hinge system for a door comprising:
a bottom hinge assembly comprising
a bottom hinge door member affixed to the door comprising,
an axial load arm that is threadedly attached axially through an axial load arm housing, wherein a position of the axial load arm is adjustable in height, and
wherein the axial load arm is capable of transitioning between a retracted position and an extended position; and
an axial load arm shoulder; and
a bottom hinge jamb member affixed to a surface comprising
a thrust bearing configured to support axial loads and minimize movement; and
wherein the axial load arm shoulder is configured to distribute weight of the door to mounting fasteners and to the thrust bearing; and
a top hinge assembly comprising
a top hinge door member affixed to the door comprising
a releasable hinge pin housing configured to receive a releasable hinge pin; and
a top hinge jamb member affixed to a jamb; and
wherein the hinge system is configured to enable lateral adjustability through non-circular mounting apertures; and
wherein the hinge system is able to be reconfigured to accommodate installation for both left-hand and right-hand doors by repositioning the axial load arm housing and hinge pin housing.

2. The hinge system of claim 1, wherein the axial load arm is threadedly adjustable within the axial load arm housing.

3. The hinge system of claim 1, wherein the axial load arm transitions between a retracted position during installation and an extended position during operation.

4. The hinge system of claim 1, wherein the axial load arm shoulder distributes weight to both the mounting fasteners and the thrust bearing.

5. The hinge system of claim 1, wherein both the top hinge assembly and the bottom hinge assembly are independently adjustable in a horizontal direction, and the axial load arm is adjustable in a vertical direction.

6. The hinge system of claim 1, wherein the non-circular mounting apertures allow for left-right adjustment of the bottom and top hinge door members and front-back adjustment of the bottom and top hinge jamb member.

7. The hinge system of claim 1, wherein the hinge system is constructed from materials selected from steel, aluminum, brass, or reinforced polymer to provide structural durability.

8. The hinge system of claim 1, wherein the hinge system is configured to support hidden or secret panel doors.

9. A hinge system for a door comprising:
a bottom hinge assembly comprising
a bottom hinge door member configured for attachment to a door;
a bottom hinge jamb member comprising a thrust bearing disposed within an annular recess, wherein the thrust bearing includes a bottom hinge jamb aperture; and
an axial load arm comprising an axial load arm trunnion that extends into the bottom hinge jamb aperture, the trunnion having a smooth surface; and
a top hinge assembly comprising
a top hinge door member configured for attachment to a door; and
a top hinge jamb member; and
a releasable hinge pin assembly comprising
a releasable hinge pin housing configured to receive the releasable hinge pin;
a hinge pin bearing; and
a tool-accessible axial recess within the releasable hinge pin housing; and
wherein the hinge system is configured to minimize clearance requirements between the top and bottom of a door and a jamb while maintaining smooth pivoting operation; and
wherein the hinge system is configured such that the door sits flush with a surrounding wall and jamb.

10. The hinge system of claim 9, wherein the axial load arm trunnion has a smooth surface to reduce abrasive wear.

11. The hinge system of claim 9, wherein the releasable hinge pin housing is adjustable to accommodate different door thicknesses.

12. The hinge system of claim 9, wherein the annular recess of the bottom hinge jamb member houses the thrust bearing and secures the axial load arm during operation.

13. The hinge system of claim 9, wherein the hinge system is constructed from materials selected from steel, aluminum, brass, or reinforced polymer for durability.

14. The hinge system of claim 9, wherein both the top hinge assembly and the bottom hinge assembly are independently adjustable in a horizontal direction, while the axial load arm is adjustable in a vertical direction.

15. The hinge system of claim 9, wherein the tool-accessible axial recess enables a user to remove the hinge pin using a specialized extraction tool.

16. The hinge system of claim 9, wherein the hinge system aids in concealed door applications by allowing the door to sit flush with a surrounding wall and jamb.
